(19) United States
(12) Patent Application Publication
(10) Pub. No.: US 2001/0038416 A1
(43) Pub. Date: Nov. 8, 2001

(54) Method and device for correcting defective pixels of an image sensor

(76) Inventors: Ivo Koren, Munchen (DE); Heribert Geib, Grafing (DE); Ulrich Ramacher, Munchen (DE); Stephane Kirmser, Munchen (DE)

Correspondence Address: LERNER AND GREENBERG, P.A., Post Office Box 2480, Hollywood, FL, 33020-2480, US

(21) Appl. No.: 09/822,021

(22) Filed: Mar. 30, 2001

Related U.S. Application Data
(63) Continuation of application No. PCT/DE99/02992, filed on Sep. 17, 1999.

(30) Foreign Application Priority Data
Sep. 30, 1998 (DE) 198 45 002.8

(51) Int. Cl. H04N 3/14

(52) U.S. Cl. 348/294

(57) ABSTRACT

Defective pixels of an image sensor are corrected by the device having an interpolator, a defect column memory, and a switch that changing the output signal under the control of the defect column memory. Depending on a defect signal from the defect column memory, input pixel data are output as output pixel data in a defect-free case and pixel data interpolated from adjacent pixel data are output as output pixel data in a defect case. The defect signal is generated from an image line address and an image column address such that a pointer memory is addressed by the image line address, wherein the pointer memory contains a pointer for each of at least some of the image lines, the pointer addressing a defect column memory with column numbers stored therein of defective image columns. The column number is read from the defect column memory, the column number is compared with the column address, and the defect signal is formed from the comparison.

### CROSS-REFERENCE TO RELATED APPLICATION

This is a continuation of copending International Application PCT/DE99/02992, filed Sep. 17, 1999 which designated the United States.

### BACKGROUND OF THE INVENTION

### Field of the Invention

The invention relates to a method and a device in which defective pixels of an image sensor are stored in a defect memory and the output signals of the defective pixels are replaced by interpolation from the adjacent pixels.

The term “image sensor” as used in this context is to be understood to mean, in particular, CMOS image sensors which contain a large number of pixels, for example 720×576 pixels for TV resolution. Due to the dictates of technology and production, all the pixel structures are fully functional in this case only in a small percentage of all the chips. In most of the chips, a plurality of defective pixels would be seen in the recorded image, with the defective pixels either being continuously white or black or their gray-scale value transfer property differing in comparison with the adjacent pixels. A typical spatial defect distribution is uncorrelated, and the defect frequency lies in the range of tenths of a percent (thousandths range). In a digital video data stream it is simple to mask out such defects by linear interpolation of the gray-scale values of the pixels adjacent to the defect. For each pixel, by way of an example, the arithmetic means is formed from the preceding and succeeding pixel values. Depending on the position of the pixel in the image, it is necessary, for example, to generate a defect signal indicating whether the currently transmitted pixel is correct or defective. This signal controls a multiplexer, for example, which switches either the correct or the interpolated value through to the output.

Simple storage of the defect pattern is very expensive, since for TV resolution for example, 404 kbits would have to be stored. Despite the low defect frequency of approximately 0.1%, run length coding that is to say in this case the distance between two successive defects, is unsuitable since the order of the defects depends on the size and position of a respective subimage. A further memory-saving method is to store the defect addresses in the form of line and column numbers. For both of the last-mentioned methods, however, an associative memory is required for the read-out of subimages. Such a memory is significantly more complex than a comparable customary random access memory.

### SUMMARY OF THE INVENTION

The object of the present invention is to provide a method and a device for correcting defective pixels in an image sensor which overcomes the above-noted deficiencies and disadvantages of the prior art devices and methods of this general kind, and which allows the defects to be stored on the basis of customary RAMs with the lowest possible memory requirement.

With the above and other objects in view there is provided, in accordance with the invention, a method of correcting defective pixels of an image sensor, which comprises:

depending on a defect signal, outputting input pixel data as output pixel data in a defect-free case and outputting pixel data interpolated from adjacent pixel data as output pixel data in a defect case;

generating the defect signal from an image line address and an image column address such that a pointer memory is addressed by the image line address, wherein the pointer memory contains a pointer for each of at least some of the image lines, the pointer addressing a defect column memory having stored therein column numbers of defective image columns; and

reading the column number from the defect column memory, comparing the column number with the column address, and forming therefrom the defect signal.

In accordance with an added feature of the invention, the method comprises the following steps:

storing the pointer in the pointer memory and the column numbers in the defect column memory in such a way that

in a first case with multiple defect pixels in the columns of a line, the pointer belonging to the line addresses a memory cell in the defect column memory that contains a first of the associated column numbers, and the column numbers of the further defective columns of the line are deposited in increasing order in subsequent memory cells of the defect column memory;

in a second case with multiple defective pixels in a column, the pointers of multiple different lines refer to the same cell of the defect column memory with the associated defect column number; and

in a third case without defective pixels in a line, a cell in the defect column memory provided specifically for this case is addressed with the associated pointer

In accordance with an additional feature of the invention, during a reading of a subimage, defect column numbers which are smaller than the column numbers of the subimage are overread and not corrected.

In accordance with another feature of the invention, a last respective defect column of a respective line is identified with a continuation bit that is present one per defect column number.

With the above and other objects in view there is also provided, in accordance with the invention, a device for correcting defective pixels of an image sensor, comprising:

an input receiving input pixel data;

a defect memory unit addressable with an image line number and an image column number, and having an output;

an interpolator connected to the input and receiving the input pixel data and having an output;

a changeover switch connected to the interpolator and the defect memory unit and controlled by a defect signal, the changeover switch, in dependence on the defect signal, outputting either the input pixel data or output pixel data present at the output of the interpolator;

the defect memory device including a pointer memory, an address advancing device, and a defect column memory, whereby the pointer memory is addressed by the image line number and a content of a cell thus addressed addresses, via the address advancing device, the defect column memory, and the defect column memory outputs a defect column number for the line with the relevant image line number; and

a comparator connected to compare the image column number with the defect column number from the defect column memory and to form therefrom the defect signal.

In accordance with a further feature of the invention, the defect column memory is configured with one continuation bit per defect column number; and the address advancing unit is controllable by the continuation bit.

In accordance with a concomitant feature of the invention, a further comparator is connected to ascertain whether the defect column number is smaller than the column number, and wherein the address advancing device advances the address of the defect column memory if the continuation bit is set.

In sum, just two customary RAMs and only a small number of further components are required for the invention. The number of memory cells in the first random access memory thereby corresponds to the line number of the image and the second random access memory requires, for example, only approximately 1000 memory locations.

Other features which are considered as characteristic for the invention are set forth in the appended claims.

Although the invention is illustrated and described herein as embodied in method and device for correcting defective pixels of an image sensor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a general block diagram of a device for correcting defective pixels with a defect memory device;

FIG. 2 is a block representation for illustrating the memory addressing in the defect memory device of FIG. 1;

FIG. 3 is a schematic block diagram for elucidating the method according to the invention; and

FIG. 4 is an schematic circuit diagram of an exemplary embodiment of the device according to the invention.

### DESCRIPTION OF THE PREFERRED EMBODIMENTS

Referring now to the figures of the drawing in detail and first, particularly, to FIG. 1 thereof, there is seen a general block diagram which aids in elucidating the correction of defective pixels of an image sensor. The system includes an interpolation device INTER, a changeover switch MUX, and a defect memory device DS. The defect memory device DS is supplied with an image line address Line and an image column address Column and, depending on these, yields a defect signal Defect, which drives the changeover switch MUX. If no defect is present, in other words, if the signal defect is equal to zero, input image data Input are switched through directly as output image data Output. In the other case, if a defect is present at that location of the image sensor which is addressed by Line and Column, in other words, if the signal Defect is equal to one, the input image data Input of adjacent pixels are interpolated linearly here, for example, and switched through by the changeover switch to the output for the output pixel data.

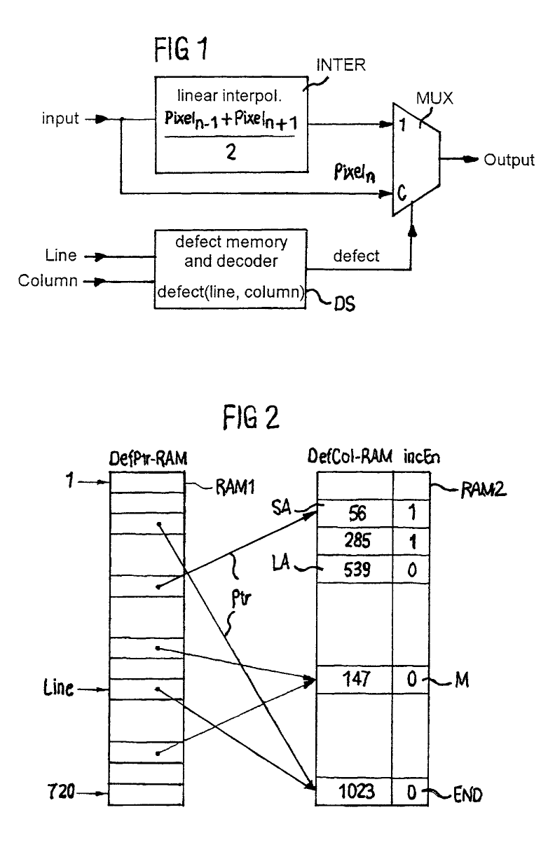

With reference to FIG. 2, the defect memory device DS of FIG. 1 contains two random access memories RAM1 and RAM2. The first random access memory RAM1 serves as a pointer memory and is directly addressed by the image line address Line. The memory cells of the pointer memory contain pointers Ptr, which address cells in the second random access memory RAM2, which serves as a defect column memory. Different addressing situations occur during the addressing of the defect column memory, and three cases shall be specially emphasized:

In the first case, one of the pointers Ptr points to a cell with the start address SA, in which a defect column number 56 is stored here, for example. In addition to each defect column number, a respective individual continuation bit incEn is also stored in the defect column memory. That bit indicates that there are still further defective columns in the image line Line. The further defective columns directly follow the cell with the start address SA and a last defect column of the image line Line is identified by the fact that the associated continuation bit is zero, and is equal to one in the case of the remaining defect columns of this line. The cell addressed by the start address SA in this case, contains the defect column number 56 and this is followed here by a cell which has a defect column number 285, and after that a cell which is addressed by a last address LA and has a defect column number 539 which is intended overall to indicate that the defect column numbers of an image line are stored in ascending order.

The second case indicated here is where a plurality of defective pixels are present in a column. In this case, a plurality of pointers Ptr point to one and the same cell M in the defect column memory, which in this case comprises the defect column number 147, for example, and the continuation bit of which is zero, of course. In the case where a plurality of lines have a defect in the same column, a plurality of pointers can point to the same entry in the defect column memory, as a result of which the maximum number of defects that can be stored will even exceed the number of words in the defect column memory.

In the last case, all pointers Ptr associated with image lines without defects jointly point, for example, to a last cell END of the defect column memory.

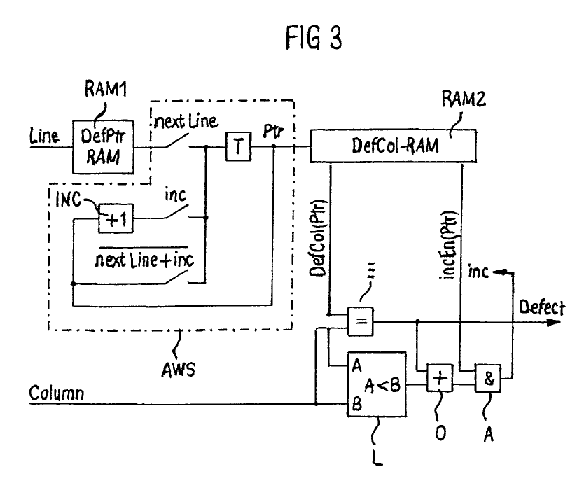

Referring now to FIG. 3, there is represented the defect memory device DS in greater detail in the form of a block diagram, and the method according to the invention will now be explained with reference to the figure. The image line address Line once again addresses the memory RAM1 whose read-out data are transferred to an address advancing unit AWS, within which the pointers Ptr are then formed in the form of addresses for the defect column memory RAM2. A delay element T serves merely for temporally decoupling the input and the output of the address advancing unit AWS. In practice the next line in the defect column memory is calculated in the unit AWS, the three cases explained in more detail in connection with FIG. 2 being distinguished and direct address transfer, incrementing of the addresses or retention of the previous address being effected. In the case where a whole frame is sensed by the image sensor, the image column Column is checked for identity with the defect column number read-out from the memory RAM2 in a comparison device E and, in the event of identity, the defect signal Defect is yielded. A continuation signal inc is formed from the associated continuation bit incEn by ANDing with the defect signal. The continuation signal inc causing the address advancing unit to increment the line address of the defect column memory.

In the case where only a subimage of the image sensor is read out, there may be one or more defects to the left of the desired image window. The corresponding entries must then be skipped. By way of example, if the subimage begins only with the column number 100, then in the example of FIG. 2 the defect column entry 56, at address SA in the memory RAM2, would have to be skipped, so that the address assignment between the image sensor and the defect memory once more is effected correctly. For this purpose, the image column number Column is compared with the defect column number from the memory RAM2 in a comparator L and, if the defect column number is smaller than the column number, in the address advancing unit AWS incrementing is triggered by the signal inc until the defect column numbers lie within the subimage of the image sensor. In this case, the output signal of the comparator L is logically combined with the defect signal Defect in an OR circuit O and the output signal of the OR circuit is in turn logically combined with the continuation bit incEN with the aid of an AND gate A to form the signal inc, since there must be further defects (incEn=1) in the line and thus also in the subimage.

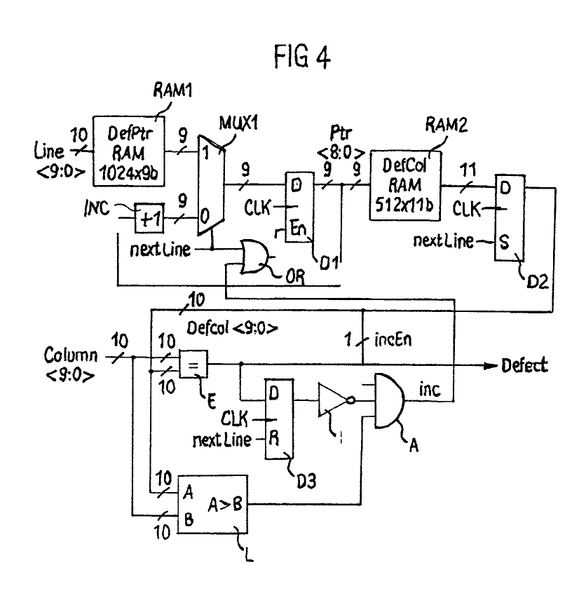

FIG. 4 represents an example of a concrete realization of the device according to the invention. In this case, the pointer memory RAM1 has 1024 9-bit words and the defect column memory RAM2 has 512 11-bit words. The memory RAM1 is addressed by an image line number having a width of 10 bits, and yields a pointer ptr having a width 9 bits which is fed as address via a multiplexer MUX1 and a register D1 to the defect column memory RAM2. At the output of the defect column memory, an output signal having a width of 11 bits is fed to a further register D2, the 11 bits being composed of a defect column number having a width of 10 bits and the continuation bit incEn. The defect column number is compared with the image column number in an equivalent circuit E and the defect signal Defect is yielded. The defect signal is fed via a 1-bit register, which can be reset by an internal line advancing signal nextLine, and an inverter I to an input of an AND circuit A, which has a further input supplied with the continuation bit incEn. Furthermore, the column number or image column address is compared with the defect column number in a comparator circuit L and it is ascertained whether the defect column number DefCol is smaller than the column number Column. The output signal of the comparator circuit L is connected to a further input of the AND circuit A, which, for its part, forms the continuation signal inc. This continuation signal is ORed with an internal signal and fed to the Enable input of the first register D1. The multiplexer MUX1 has a zero input having a width of 9 bits which receives the incrementing pointer signal Ptr generated by the incrementing circuit INC. The changeover of the multiplexer MUX1 is effected by the internal line signal nextLine.

This circuit can be used as a defect correction unit of a digital single chip camera. In order to achieve the demanded processing speed, in this case the register D2 is connected between the defect column memory RAM2 and the comparators. As a result of that, after identification of a defective pixel, and the incrementing of the pointer Ptr, the defect column number associated with the pointer and the continuation bit associated with the pointer are not available until one clock cycle later. To ensure that the pointer is not incremented a second time because the conditions column number Column>defect column number and continuation bit incEn=1 are fulfilled simultaneously, the incrementing of the pointer Ptr is made dependent on the defect signal delayed by the register D3, and, consequently, if a defect has been identified and the pointer incremented in the last clock cycle, the incrementing is prevented in the present clock cycle.

We claim:

1. A method of correcting defective pixels of an image sensor, which comprises:
depending on a defect signal, outputting input pixel data as output pixel data in a defect-free case and outputting pixel data interpolated from adjacent pixel data as output pixel data in a defect case;
generating the defect signal from an image line address and an image column address such that a pointer memory is addressed by the image line address, wherein the pointer memory contains a pointer for each of at least some of the image lines, the pointer addressing a defect column memory having stored therein column numbers of defective image columns; and
reading the column number from the defect column memory, comparing the column number with the column address, and forming therefrom the defect signal.

2. The method according to claim 1, which comprises
storing the pointer in the pointer memory and the column numbers in the defect column memory in such a way that in a first case with multiple defect pixels in the columns of a line, the pointer belonging to the line addresses a memory cell in the defect column memory that contains a first of the associated column numbers, and the column numbers of the further defective columns of the line are deposited in increasing order in subsequent memory cells of the defect column memory;
in a second case with multiple defective pixels in a column, the pointers of multiple different lines refer to the same cell of the defect column memory with the associated defect column number; and
in a third case without defective pixels in a line, a cell in the defect column memory provided specifically for this case is addressed with the associated pointer

3. The method according to claim 1, which comprises, during a reading of a subimage, overreading and not correcting defect column numbers which are smaller than the column numbers of the subimage.

4. The method according to claim 1, which comprises
identifying a last respective defect column of a respective line with a continuation bit that is present one per defect column number.

5. A device for correcting defective pixels of an image sensor, comprising:
an input receiving input pixel data;
a defect memory unit addressable with an image line number and an image column number, and having an output;
an interpolator connected to said input and receiving the input pixel data and having an output;
a changeover switch connected to said interpolator and said defect memory unit and controlled by a defect signal, said changeover switch, in dependence on the defect signal, outputting either the input pixel data or output pixel data present at said output of said interpolator;
said defect memory device including a pointer memory, an address advancing device, and a defect column memory, whereby said pointer memory is addressed by the image line number and a content of a cell thus addressed addresses, via said address advancing device, said defect column memory, and said defect column memory outputs a defect column number for the line with the relevant image line number; and
a comparator connected to compare the image column number with the defect column number from said defect column memory and to form therefrom the defect signal.

6. The device according to claim 5, wherein
said defect column memory is configured with one continuation bit per defect column number; and
wherein said address advancing unit is controllable by the continuation bit.

7. The device according to claim 5, which comprises a further comparator connected to ascertain whether the defect column number is smaller than the column number, and wherein said address advancing device advances the address of said defect column memory if the continuation bit is set.
